(19) United States
(12) Patent Application Publication
(10) Pub. No.: US 2006/0044559 A1
(43) Pub. Date: Mar. 2, 2006

(54) Color match system and method

(76) Inventor: Lela Foy-Watson, Longview, TX (US)

Correspondence Address: America Invents, 220 Halleck St. G-100, San Francisco, CA, 94129, US

(21) Appl. No.: 10/924,784

(22) Filed: Aug. 25, 2004

(51) Int. Cl. G01J 3/50

(52) U.S. Cl. 356/425

(57) ABSTRACT

The invention relates to an easy to use color matching system and method designed to aid an individual in making desirable selections regarding color, such as for clothing, shoes, paint, furniture, window treatments, etc. It also preferably aids designers in matching colors to a standard color selection chart that may be downloaded or matched to a color meter reading.

### FIELD OF INVENTION

The invention relates to a color match system, and in particular, a system and method for matching colors on clothing and home decor items, etc.

### BACKGROUND OF THE INVENTION

Color matching is an important element relative to the successful selection of clothing, home decor items, etc. Too often colors are incorrectly matched, leading to unattractive and sometimes hideous color combinations.

When one piece of clothing, for example, has to be color coordinated with another clothing, i.e., a blouse with a skirt, a shirt with a suit, etc., people often physically compare the colors of the garments side by side to determine whether there's a good match. This may require the person to take a piece of clothing from home into the store and physically inspect the garments. It may also require the person to have a relatively good sense of color, as well as what looks good, which isn't always the case. In fact, in many situations, in addition to matching colors between garments, the wearer may also have to match the clothing selection with the wearer's skin, hair and/or eye color, in which case, the person making the decision not only has to match the garments, but also has to coordinate his or her personal traits with the clothing selection, which isn't always an easy task.

Another example is in the home decor field, such as in the case of paint, furniture, carpeting, window treatments, etc. A house may come, for example, with a certain color, on the walls, carpeting, etc., and the owner may need to select materials with the appropriate colors for the furniture, drapes, blinds, etc., to match the existing home. In this respect, it is often difficult for the person to take a sample of the wall or carpeting to the store, and would otherwise be forced to take a sample swatch of material or paint back home from the store, in which case he would have to attempt to match the colors for himself, or else he would be forced to hire a home decorator to match the colors. Needless to say, the success of a home project, or the design of an entire home, in some cases, may depend on making the right color selections, wherein a mistake or failure could be embarrassing and costly to correct.

What is needed, therefore, is an easy to use color matching system and method designed to aid an individual in making desirable selections regarding color, such as for clothing, shoes, paint, furniture, window treatments, etc. It also preferably aids designers in matching colors to a standard color selection chart that may be downloaded or matched to a color meter reading.

### SUMMARY OF THE INVENTION

The present invention preferably solves the following problems:

First, it can accurately record the color of existing articles, such as clothing, paint, furniture, etc., so that the user can match the colors of the existing articles with colors of articles at a retail store or the like without having to carry the existing articles into the store.

Second, it can check the color of an article, such as clothing, with respect to the colors that are ideal for the user's skin tone, hair color and eye color.

Third, it can accurately record the color of an existing article at a retail store, so that it can be brought home and checked against an already existing color at home.

Fourth, designers who work with colors can take a remote reading of the color of any article and compare it to a standardized color process, such a Pantone® color system, without having to take the article or pieces back to match.

Fifth, the designer can check the progress of a remote project such as the painting or color decorating of a building, room, wall, furniture, artwork, advertising, etc., without having to physically be present to check the work in both locations.

Sixth, the designer can coordinate the work over the phone or later after the readings have been taken in person.

In general, the color matching system of the present invention comprises a hand-held device that has its own light-emitting source, that can be flashed, i.e., by pressing the “scan” button, onto the surface of a colored article, such as garment, paint, etc., to digitally record the color of the surface, by storing the red, yellow and blue values, as well as the light to dark values, associated with the color. These four indicators can record virtually any color in the spectrum, i.e., a rainbow.

The present invention comprises at least the following improvements. In an embodiment designed for use by consumers, the hand-held device can be used to scan a first article, such as one that the user already owns, to record the color values of that article. In the preferred embodiment, the first article can then be assigned a number, and the name of the article can be stored in the device along with the number. For instance, a type or name of clothing, and the corresponding number, can be stored on a card in the hand held device, or, in a different embodiment, the information can be stored on a palm-sized computer or processor. A plurality of “first articles” can preferably be recorded and stored in this fashion.

The user can then use the device in a different or remote location to determine whether the color of the first article, i.e., whose name and corresponding number are stored in the device, matches or is otherwise complementary with the color of the article located at the remote location, without having to bring along the first article. When the user scans an article of clothing that belongs to the user, for example, he or she can compare the color of the article that has been stored in the device, with the color of an article located at a retail establishment, wherein the device preferably tells the user whether the colors are a good match, i.e., whether they are the same color, complementary colors, or uncomplimentary colors. A complementary color is one that is different from the stored color, but would nevertheless go well with it. Conversely, the user can scan an article of clothing at a store and take the device back home to check it with an article of clothing at home.

In the preferred embodiment, the user can also preferably enter his or her skin color, hair color, eye color and/or ethnicity, or any other personal trait that the system is designed to record. In such case, the invention preferably has a program stored within the device that has ideal color combinations for each series of parameters that the user has entered. The user can then scan an article and, in addition to being able to match it with an existing article, the device can determine whether the article is a good match for that user's personal traits, including skin, hair, and eye color, etc. The invention contemplates that this feature can also be provided as the sole feature of the device, if desired.

The device also preferably has the ability to download a standard color chart, such as Pantone® or other color processing system, allowing for the individual using the device to immediately match the color readings from the desired article to the standard color in the system. This can help ensure proper color usage and to replicate the color later, using a standard color processing system, such as Pantone®.

A simple version of the device preferably includes the scanner, an LCD screen that gives simple responses such as “match” “no match” “goes with your coloring,” etc., as well as the red, yellow, and blue values. The simple version can have one or more of the preferred features discussed above. For example, in one embodiment, the user's articles may be recorded on a card that is stored within the hand-held device. Two other cards can also be included in the device, i.e., a card of color swatches showing the user's ideal colors, and a card explaining the basic rules of clothing combinations, i.e., regarding pattern mixing, etc.

A more elaborate version is contemplated where a person can scan a color from an article, and then record a picture of the article, which can be pulled up on a color screen, or transmitted to a central computer located at the user's home. The user may, in such case, have his or her entire inventory of articles stored on a site that can be accessed on the Internet. The user can then manipulate the information and compare it with items located at the retail store. In such case, a digital camera is preferably provided with the device.

The present invention can also be used by professionals, such as designers, artists, etc., wherein all of the embodiments and features discussed above can be used to record, store and then later match colors using readings generated by the device. This can be done, for example, to match colors at a remote location—such as at an office or studio, without having to take the article along, to assist in the work of matching colors and designs.

Based on the above, the main objects of the present invention are as follows:

To provide a color matching device that allows a person to store and retrieve color information about articles such as clothing, home decor items or the like, so that a person can compare the stored color with the color of an article at a remote location, such as at a clothing or home improvement store.

To provide a way for a person to determine if a particular color is attractive for his or her skin tone, hair color and eye color, etc.

To provide a color-matching device that is compact and hand-held so that it can easily be carried in a pocket or purse.

To provide a color-matching device that includes a plurality of writable surfaces for the user to record his or her articles, such as clothing items or the like, and index them with an assigned number.

To provide an alternate color matching system wherein the printed inventory of stored items is recorded in a memory processor and can be seen on an LCD type screen.

To provide an alternate embodiment wherein a digital camera is built into the device and a color display screen is provided that can show a picture of the actual article being matched.

### DESCRIPTION OF THE DRAWINGS

FIG. 1 shows an embodiment of the invention with the door closed;

FIG. 2 shows an embodiment of the invention with the door open;

FIG. 3 shows a flow chart of the personal trait feature of the invention;

FIG. 4 shows an individual using the invention on clothing;

FIG. 5 shows the tip of the light emitting source;

FIG. 6 shows a schematic diagram of the processor; and

FIG. 7 shows an alternate embodiment with a camera and image display feature.

### DETAILED DESCRIPTION OF THE INVENTION

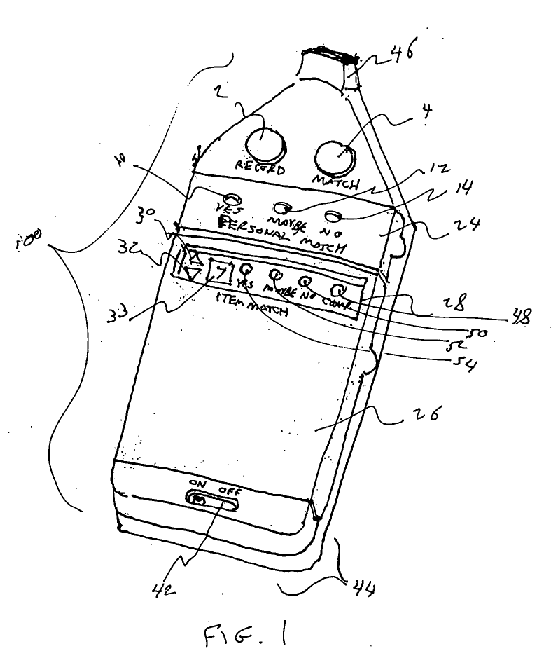

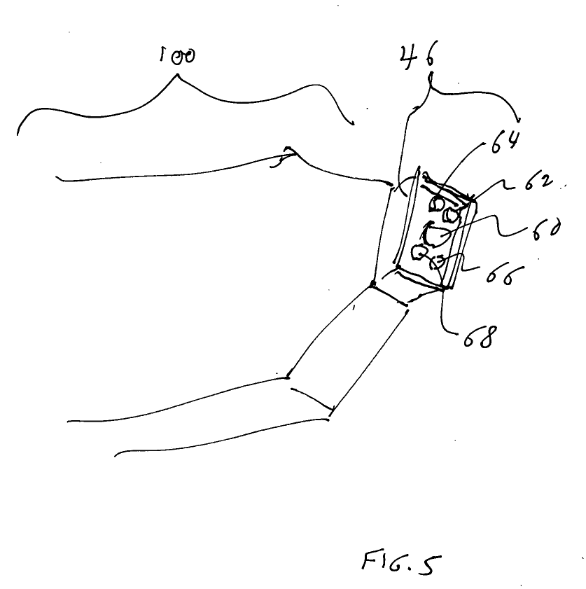

FIG. 1 shows one embodiment of the color-matching device of the present invention 100. This embodiment has an on/off switch 42 that turns the unit on. The housing 44 preferably has a light-emitting, color-reading tip 46 that can be seen more clearly in FIG. 5. A tip is shown, although any type of light-emitting source can be provided. The term tip shall hereinafter be used to mean any type of light-emitting source.

A white light source such as a xenon flash bulb or white LED or the like 60 is preferably provided on and located within the tip 46. The light 60 is preferably activated when the “record” 2 or “match” 4 button is pressed. The source preferably emits a light 60 that scans the surface of the article upon which the tip 46 is applied.

When the record 2 button is pressed, the device 100 records and stores in memory the color values or properties of the surface being scanned. When the match 4 button is pressed, as will be discussed, the device 100 attempts to make a match between an existing color or characteristic, such as one that has previously been scanned and stored in memory, and a new color of another article that is currently being scanned.

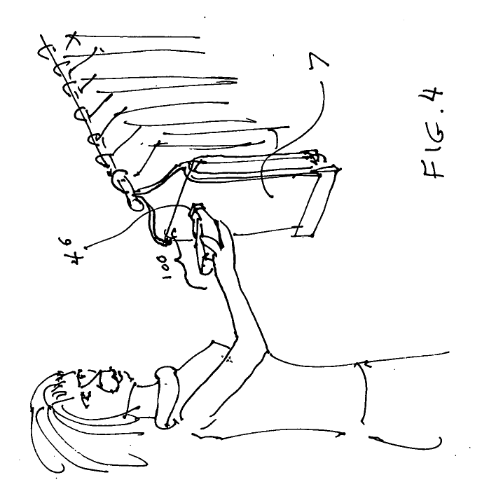

To record the color of the article, such as a garment or the like, and store it in memory, the user preferably waves or presses the tip 46 of the housing 44 onto the surface as shown in FIG. 4. When pressing the record 2 button, the white light 60 preferably flashes and four photo diodes—red 62, blue 64, yellow 66, gray scale 68, shown in FIG. 5, receive the reflected light so that the strength of red, blue, yellow and gray scale are measured and converted into digital information and stored in the microprocessor 80 located inside the device 100.

Another set of buttons 30, 32, which have up and down arrows, can also be used to cause the numeral shown in an LCD display 33 to change, either higher or lower. To record a color value for a particular article, and to later identify that article, the user preferably sets the number in display 33 first, i.e., for example “7”, which then will correspond to the name of the article that is to be scanned next. The user can identify and make a record of this article by writing the name of the article on writing surface 38, along with the corresponding number that will be displayed on display 33 for that article.

To record the color of the article designated as 7, with the correct number in the display 33, the user then points the tip 46 of device 100 and holds it against the article, as shown in FIG. 4, and presses the “record” button. The color values of the article designated in display 33 are then recorded and stored in memory in the microprocessor 80 of device 100. The user can then continue to input additional information about additional articles in the same manner, assigning different names and numbers for each one, so that they can each be identified and scanned. Generally, the user can assign numbers to articles of clothing or other colored items such as wall color or furniture color and can then “flash” each item so that each item is numbered and identified by color index and stored in the hand held device 100, wherein this information can be used for comparison purposes with other articles, such as in a remote location.

To use the “item match” portion of the device 100, the user preferably scrolls up or down on buttons 30, 32 to make the appropriate number selection on display 33 that matches the existing stored article to be matched or compared. Then the user approaches a new article such as a garment or the like and presses the “match” button 4 which causes the white light source 60 to flash and photo diodes 62, 64, 66, 68 to read the color of the new article and to match it with the stored article's color values. If there is a good color match the green “yes” 54 light will go on. If the match is close but not perfect, the yellow 52 “maybe” light will go on. If there is a poor match, the red 50 “no” light will go on. If the color is complementary to the stored color, the blue 28 light will go on. Other colors and indications for different types of matches are also contemplated by the present invention. The user may erase stored items in memory by pushing the erase button 71.

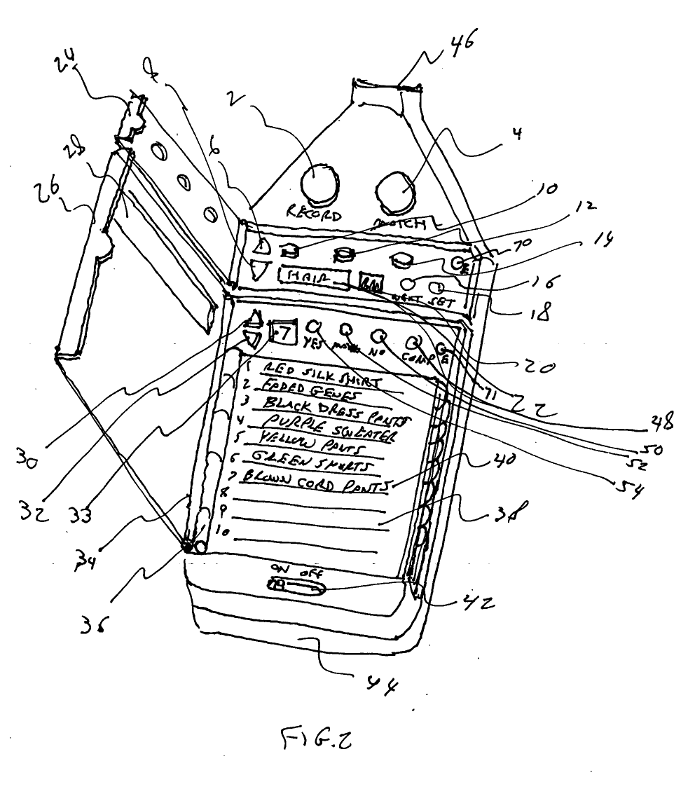

Housing doors 26, 24 are preferably provided on the device 100. FIG. 1 shows the doors closed and FIG. 2 shows the doors 24, 26 in the open position. Inside the doors, there are preferably a series of buttons and indicators, as shown in FIG. 2. Hinge 34 allows door 26 to open and close. Additional pages of written information can also be provided, wherein hinge 36 preferably allows the user to flip through a plurality of pages of information within the device 100. Alternately, a more expensive version of the device 100 can include an electronic means for writing the article's information into the device. For example, a higher end version of the device 100 can include a (Palm type) device that would include an LCD screen where all names of articles and the like could be stored in memory along with their identification numbers.

Preferably, the user can also install his or her personal color characteristics including hair color, eye color and skin color into the device 100, so that the user can determine whether a particular color (to be scanned later) matches his or her personal color traits. The user does this by first pressing the “up” 6 or “down” 8 buttons and scrolling through the choices that appear in LCD display 22, such as “hair”, “eye”, “skin tone”, etc. The user also preferably scrolls through the choices that appear on display 20, which indicates the color to be associated with the hair, eyes, skin, etc. that is designated in display 22

For example, display 22 can be set to “hair,” and display 20 can be set to “black,” indicating that the person who wants to use the device has “black hair.” When the correct information is displayed for that choice, the user can press the “set” 18 button to store the information in memory. The user can then continue to do this for every color choice, until all of the choices have been completed. The user can do this by pressing the “next” 16 button to advance to the next characteristic displayed on LCD display 22, and so forth.

Once all of the desired characteristics are set into memory in the microprocessor 80, these personal color characteristics can be referenced for comparison purposes when scanning a new article at a remote location to determine whether the particular color is suitable for the user. In such case, the device 100 is adapted with preselected information relating to these color choices based on hair color, eye color, skin tone and the like, which are well known in the fashion industry, wherein the information has been pre-programmed into the microprocessor of the present color matching device 100. This way, the user simply points the tip 46 of the device 100 on a new article, wherein one of three LED type lights will light up to indicate that the article color is either 1) very good in relation to the user's colors 10 (green light), 2) only OK in relation to the user's colors 12 (yellow light), or 3) is not good in relation to the user's colors 14 (red light). This can be made to operate automatically, or upon pressing a button (not shown) that turns this feature on. The user may erase stored items in memory by pushing the erase button 70.

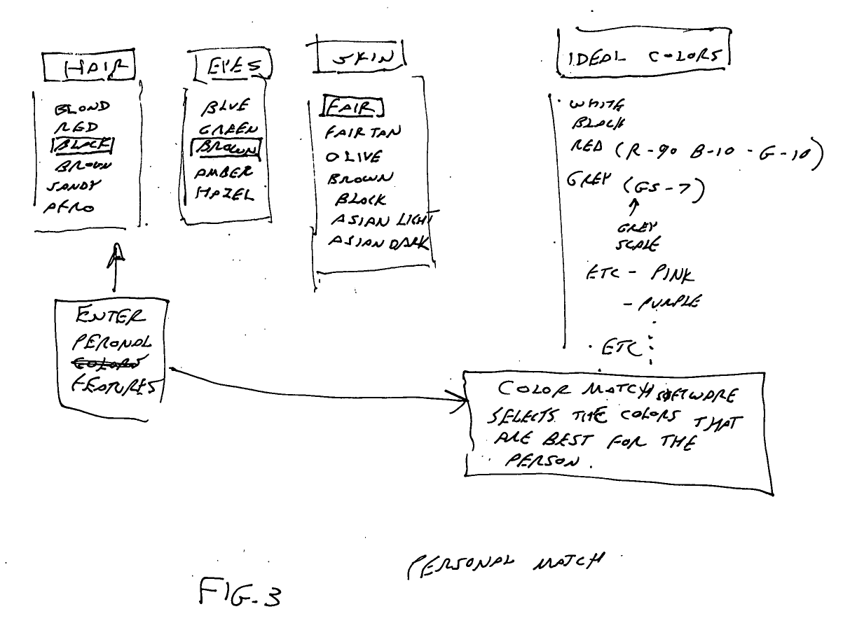

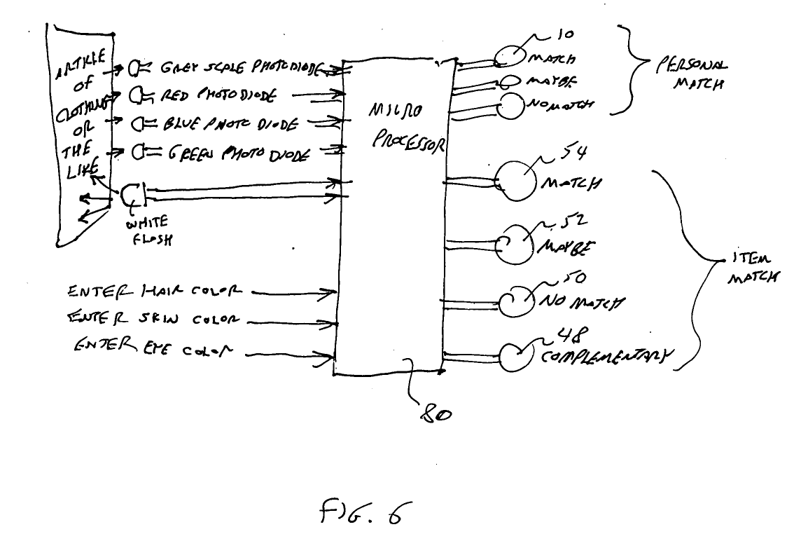

FIG. 3 shows a block diagram of the personal color selection process. FIG. 6 shows a block diagram of the inputs and outputs of the microprocessor 80.

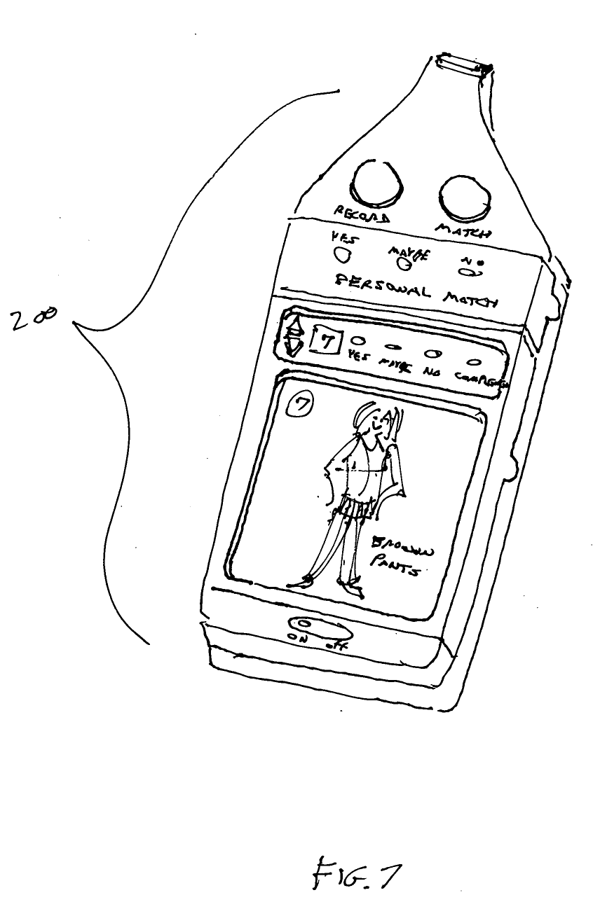

FIG. 7 shows a perspective view of an alternate embodiment 200 of the device where a color display shows a picture of the article being matched, i.e., for which the information is being recorded and stored in memory. In this higher end version of the device 100, a digital camera and a color display screen are preferably provided, so that the user can take a picture of the article to be recorded, and then actually see the article, such as an item of clothing or the like, that is to be matched.

What is claimed is:

1. A color matching device comprising:
a light emitting source for scanning and determining the color values of a surface;
a feature for recording the color values relating to a surface of a first article; and
a system for comparing the color values of the first article with color values of a surface of a second article.

2. The device of claim 1, wherein the light-emitting source emits a white light such as xenon or white LED, and can record or determine the color values of the surface based on the red, blue, yellow and grey properties of the color.

3. The device of claim 1, wherein the device allows a user to record and store color values and other information relating to the first article, wherein the color values can be determined by scanning the light emitting source onto the surface of the first article.

4. The device of claim 3, wherein the device allows the user to compare the color values of the first article with color values of the second article by scanning the light emitting source onto the surface of the second article, to determine whether the color values of the two surfaces match, or are complementary or uncomplimentary.

5. The device of claim 3, wherein the device allows the user to identify the name of the first article and assign a number to the first article, wherein the user can store a plurality of first articles, each identified by a different number.

6. The device of claim 5, wherein the device allows the user to select the number of the first article that is desired to be compared to the second article, wherein after making the selection, the user can scan the second article to determine whether the color values of the selected first article match the color values of the second article.

7. The device of claim 4, wherein the device has indicators to indicate whether the color values of the first and second articles match, or are complementary or uncomplimentary.

8. The device of claim 3, wherein the device allows the user to identify the first article by enabling an image of the first article to be taken by the device, wherein the image is stored in memory to allow the user to identify the first article, wherein the user can store a plurality of first articles, each corresponding to a different image.

9. The device of claim 5, wherein the names and numbers of the first articles can be hand written on the device, and/or an electronic memory is provided for storing information about the first articles.

10. A color matching device comprising:
a light emitting source for scanning and determining the color values of a surface;
a feature for determining or recording the color values relating to an article; and
a system for comparing a first set of color values with color values of the article.

11. The device of claim 10, wherein the light-emitting source emits a white light such as xenon or white LED, and can record or determine the color values of the surface based on the red, blue, yellow and grey properties of the color.

12. The device of claim 10, wherein the device is capable of storing at least one of a user's personal color characteristics, taken from the group consisting of hair color, skin tone, eye color, and ethnicity.

13. The device of claim 12, wherein the device allows the user to select at least one of the user's personal color characteristics using a setting feature, wherein the device is able to determine whether the user's personal color characteristics selected by the setting feature which represents the first set of color values matches or is complementary or uncomplimentary with the color values of the article.

14. The device of claim 10, wherein the device allows the user to compare the color values of a first article with color values of a second article, by scanning the light emitting source onto the surface of the first article, and then scanning the light emitting source onto the surface of the second article, to determine whether the color values of the two surfaces match, or are complementary or uncomplimentary.

15. The device of claim 14, wherein the device allows the user to identify the name of the first article and assign a number to the first article, wherein the user can store a plurality of first articles, each identified by a different number, wherein the device allows the user to select the number of the first article to be compared to the second article, wherein after making the selection, the user can scan the second article to determine whether the color values of the selected first article match the color values of the second article.

16. A method of comparing color values of articles, comprising:
scanning a surface of a first article to determine its color values;
storing information about the first article;
selecting the information relating to the first article for comparison purposes;
scanning a surface of a second article; and
comparing the color values of the first article with the color values of the second article to determine whether the color values match or are complementary.

17. The method of claim 16, wherein the method comprises the step of storing information about a plurality of first articles, and assigning a corresponding number to each of said first articles, and selecting the number of the first article to be compared with the second article.
